(19) United States
(12) Patent Application Publication
(10) Pub. No.: US 2017/0228175 A1
(43) Pub. Date: Aug. 10, 2017

(54) MEMORY CONTROLLER, MEMORY SYSTEM MANAGING REFRESH OPERATION AND OPERATING METHOD OF THE MEMORY CONTROLLER

(71) Applicant: SAMSUNG ELECTRONICS CO., LTD., SUWON-SI (KR)

(72) Inventor: MOON-GYUNG KIM, SUWON-SI (KR)

(21) Appl. No.: 15/017,823

(22) Filed: Feb. 8, 2016

(51) Int. Cl. G06F 3/06

(52) U.S. Cl. CPC G06F 3/0619; G06F 3/0644; G06F 3/0658; G06F 3/0673

(57) ABSTRACT

A memory controller, a memory system managing refresh operations for respective banks and an operating method of the memory controller are provided. The operating method of the memory controller includes determining the banks requested for access by analyzing an address, selecting at least one bank predicted to be accessed based on the determination result, setting a refresh order of the banks according to the selecting result, and controlling refresh operations for the banks according to the set order.

### CROSS-REFERENCE TO RELATED APPLICATIONS

A claim of priority under 35 U.S.C. §119 is made to Korean Patent Application No. 10-2015-0044390, filed on Mar. 30, 2015, in the Korean Intellectual Property Office, the entire content of which is hereby incorporated by reference.

### BACKGROUND

The present inventive concept relates to a memory controller, and more particularly, to a memory controller, a memory system managing refresh operations for respective banks and an operating method of the memory controller.

As memory devices have been widely used in high-performance electronic systems, their capacity and speed thereof have constantly increased. Dynamic Random Access Memory (DRAM) is an example of a volatile type semiconductor device that reads data based on charges stored in a capacitor.

A memory controller typically provides various commands and addresses to the memory device, and controls various operations including memory operations. A memory cell array included in the memory device may include a plurality of memory regions (for example, banks), and a refresh operation for retaining data may be performed for each of the banks. Refresh operations may however affect memory operations such as writing/reading operations.

### SUMMARY

Embodiments of the inventive concept provide a memory controller capable of matching a memory region in which data access is performed with a memory region in which a refresh operation is performed.

According to an embodiment of the inventive concept, there is provided an operating method of a memory controller configured to manage an access operation corresponding to a plurality of banks. The operating method includes determining a bank requested for access by analyzing an address, selecting of at least one bank predicted to be accessed based on the determination result, setting of a refresh order of the banks according to the selecting result, and controlling of refresh operations for the banks according to the set order.

In an embodiment of the inventive concept, the selection of at least one bank may be performed to select at least one bank that is not refreshed from among the banks.

In an embodiment of the inventive concept, the setting of the refresh order of the banks may be performed to set the refresh order of at least one bank that is predicted to be accessed next so as to be refreshed later than other banks.

In an embodiment of the inventive concept, the setting of the refresh order of the banks may be performed to change a refresh order of the banks that are not refreshed from among the banks according to the selecting result.

In an embodiment of the inventive concept, each of the banks may include a plurality of rows and the refresh operation is performed in a row unit of each of the banks. The setting of the refresh order of the banks may be performed to set a refresh order of any one of the rows of the banks.

According to an embodiment of the inventive concept, there is provided an operating method of a memory controller configured to manage a plurality of memory regions. The operating method includes performing refresh operations corresponding to some of the memory regions, receiving a request for access from the outside and an address corresponding thereto, changing a refresh order of remaining memory regions that are not refreshed according to an analyzing result of the address, and performing refresh operations corresponding to the remaining memory regions according to the changed refresh order.

According to an embodiment of the inventive concept, there is provided an operating method of a memory system including a plurality of banks. The operating method includes selecting a first bank requested for access according to an external address, referencing information in order to determine a second bank predicted to be accessed, adjusting a refresh order of the second bank in order not to match the bank to be accessed and a bank to be refreshed, accessing data to the first bank, and refreshing the second bank after finishing a data access operation to the second bank and a row of the second bank is closed.

According to the embodiments of the inventive concept, by managing of the data access and the refresh operation corresponding to each of the banks, an effect of the refresh operation on the data access operation is reduced by reducing a probability of matching a memory region in which the data access is performed with a memory region in which the refresh operation is performed. Thus, memory system performance may be improved.

Furthermore, according to the embodiments of the inventive concept, a data access and a refresh operation may be performed so that data is stably retained in a memory device while reducing a probability of delay in execution timing of the refresh operation by performing the data access.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram illustrating a memory system, according to an embodiment of the inventive concept;

FIG. 2 is a block diagram illustrating a memory controller in FIG. 1, according to an embodiment of the inventive concept;

FIG. 3 is a block diagram illustrating a memory device in FIG. 1 block diagram of the memory controller in FIG. 1, according to an embodiment of the inventive concept;

FIG. 4 is a flowchart illustrating an operating method of a memory system, according to an embodiment of the inventive concept;

FIGS. 5A and 5B are block diagrams illustrating an access prediction operation, according to an embodiment of the inventive concept

FIG. 6 is a block diagram illustrating setting refresh orders of respective banks, according to an embodiment of the inventive concept;

FIGS. 7, 8, 9 and 10 are tables illustrating refresh orders of respective banks, according to an embodiment of the inventive concept;

FIGS. 11 and 12 are block diagrams illustrating signal transceiving between a memory controller and a memory device, according to an embodiment of the inventive concept;

FIGS. 13 and 14 are waveform diagrams illustrating signals in a refresh operation, according to an embodiment of the inventive concept;

FIGS. 15A and 15B are block diagrams illustrating setting refresh orders of respective banks, according to an embodiment of the inventive concept;

FIGS. 16A and 16B are block diagrams illustrating setting refresh orders of respective banks, according to an embodiment of the inventive concept;

FIG. 17 is a block diagram illustrating a memory controller, according to another embodiment of the inventive concept;

FIGS. 18A and 18B are block diagrams illustrating setting refresh orders of respective banks, according to an embodiment of the inventive concept;

FIG. 19 is a flowchart illustrating an operating method of a memory system, according to an embodiment of the inventive concept;

FIG. 20 is a block diagram illustrating a data process system including a memory controller and a memory device, according to an embodiment of the inventive concept;

FIG. 21 is a view illustrating a memory module, according to an embodiment of the inventive concept; and

FIG. 22 is a block diagram illustrating a computing system including a memory system, according to an embodiment of the inventive concept.

### DETAILED DESCRIPTION OF THE EMBODIMENTS

Various embodiments of the inventive concept will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Dynamic Random Access Memory (DRAM) is a semiconductor memory device with a finite data retention characteristic. Thus, even a normal memory cell does not guarantee the validity of stored data after a specific period of time lapses. In order to retain data stably, a refresh policy is used. Accordingly, a memory controller provides commands and/or addresses to the DRAM so that memory cells thereof may be refreshed for each refresh period set by a specification value. Furthermore, the DRAM may autonomously enter a self refresh mode and refresh the memory cells by generating addresses internally without receiving another command received from the memory controller.

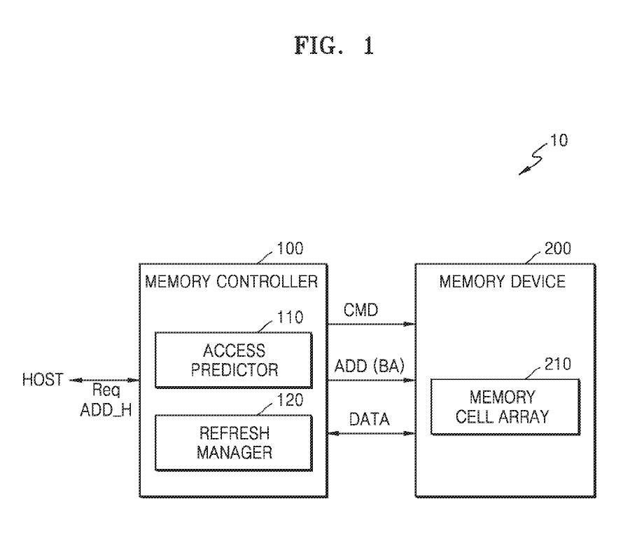

FIG. 1 is a block diagram illustrating a memory system 10, according to an embodiment of the inventive concept. As illustrated in FIG. 1, the memory system 10 includes a memory controller 100 and a memory device 200. The memory controller 100 controls a memory operation such as writing/reading by providing various control signals to the memory device 200. For example, the memory controller 100 accesses data DATA of a memory cell array 210 by providing a command CMD and an address ADD to the memory device 200. The command CMD may include commands related to various memory operations such as data writing/reading. Furthermore, the command CMD may include specific operations related to the DRAM, for example, a refresh command in order to refresh memory cells when the memory device 200 includes DRAM cells.

The memory cell array 210 may include a plurality of memory regions. The memory region may be variously defined. For example, the memory cell array 210 may include a plurality of rows, a plurality of banks, and a plurality of ranks. A memory operation or a refresh operation may be performed for each of the banks when the memory cell array 210 includes banks. Accordingly, the address ADD received from the memory controller 100 may include a bank address BA.

The memory controller 100 may access the memory device 200 according to a request from a host HOST. For example, the memory controller 100 may receive a request Req related to types of access and an address ADD_H (hereinafter, an address from the host is referred to as a hosts address) instructing a region to be accessed. The memory controller 100 may process the request Req received from the host and may process the host address ADD_H. The memory controller 100 may provide the command CMD and the address ADD to the memory device 200 based on the process.

The memory system 10 may communicate with the host by using interface protocols such as a peripheral component interconnect-express (PCI-E), an advanced technology attachment (ATA), a serial ATA (SATA), a parallel ATA (PATA), or a serial attached SCSI (SAS), or the like. Furthermore, the interface protocols between the memory system 10 and the host are not limited thereto, and may be one from among other interface protocols such as a universal serial bus (USB), a multi-media card (MMC), an enhanced small disk interface (ESDI), and integrated drive electronics (IDE) or the like.

According to embodiments of the inventive concept, the memory controller 100 includes an access predictor 110 and a refresh manager 120. The memory controller 100 may determine a memory region, which is requested for access by the host HOST, by analyzing (or by decoding) the host address ADD_H received from the host HOST. Hereinafter, as an example, it will be considered that the memory region includes banks, but embodiments of the inventive concept are not limited thereto. However, the memory operation and/or the refresh operation may be managed for each various memory regions.

The access predictor 110 may predict at least one bank having a higher probability of being accessed next, based on a bank currently requested for access. For example, data information of a specific size including a data request for access received from the host may be written or read in/from at least two banks, and the memory controller 100 may store status information representing a storage state of the data information. The access predictor 110 predicts banks having a higher probability of being accessed next by considering the bank that is requested for access received from the host and the storage state of the data information including the access-requested bank, and may select at least one bank according to the prediction result.

Meanwhile, a data prediction operation may be performed by other various methods according to embodiments of the inventive concept. For example, at least one table related to data access for each bank is stored in the memory controller 100, and information stored in the tables may be updated whenever the data access is performed. In embodiments of the inventive concept, a table storing information related to an access history and a table storing information representing a probability of access for each bank are stored in the memory controller 100, and at least one bank having a higher probability of request for access next may be predicted by referring to the tables when a request for data access is received.

The refresh manager 120 may generally manage a refresh operation corresponding to the memory device 200. For example, the refresh manager 120 differentiates and controls refresh timing so that a refresh operation corresponding to the memory cell array 210 is performed according to a period previously set. Furthermore, the refresh manager 120 may control the refresh operation based on the prediction result of the access predictor 110. For example, it is possible to set a refresh order of a plurality of banks based on information about a bank currently requested for access and/or at least one bank predicted to be accessed next.

Refresh operations may be managed for respective banks when the memory cell array 210 includes a plurality of banks. For example, each of the banks may include a plurality of rows ROW, and the refresh operations may be performed by opening at least one row of each of the banks. In an embodiment of the inventive concept, when a refresh operation for a first row of the banks according to an order set by a predetermined value is completed, a refresh operation for a second row may be performed according to the predetermined order. When the banks include first to Nth banks in an initial setting, the refresh operation may be sequentially performed in the first bank to the Nth bank.

The refresh order of the banks may be changed based on the prediction result of the access predictor 110. For example, when one of the banks predicted to be accessed next is selected, a refresh order of the selected bank is changed so that the selected bank is refreshed last among the banks. When a third row of each of the banks is refreshed according to the changed order and a second bank is predicted to be accessed next, the second bank (or a third row of the second bank) may be refreshed last among the banks (or third rows of other banks).

Even though it was described for convenience of explanation that the refresh orders of respective banks are changed for a row unit, the refresh orders of respective banks may be changed during a refresh operation for one row according to embodiments of the inventive concept as described below.

For example, a first row of a first bank may be refreshed in respective refresh operations for first rows of first to fourth banks. According to existing orders, the first row of the second bank needs to be refreshed next. However, it may be predicted that the second bank is to be accessed next according to an analyzing result of an address received from the host, and an order of the first row of the second bank is changed so that the first row of the second bank is refreshed last based the changed order. Accordingly, the first row of the third bank is refreshed next and the first row of the fourth bank is refreshed next to the first row of the third bank. Furthermore, the first row of the second bank may be refreshed last.

In the above described embodiment of the inventive concept, an operation of predicting a bank to be accessed next may be realized in various ways. For example, a bank to be requested for access by immediate next request after a request currently received may be predicted, or a bank to be requested for access by at least one request selected from among a plurality of requests to be received next may be predicted.

According to the above described embodiment of the inventive concept, it is possible to prevent deterioration of a memory system performance by refreshing banks without disturbing existing access. For example, in order to refresh the first bank in a state of opening at least one row of the first bank to be accessed, it is required to refresh a row to be refreshed after closing the opened row. It is possible to access data in a state of opening at least one row by providing only writing/reading commands including a column address to the memory device 200. However, a command for opening at least one row of the first bank needs to be provided to the memory device 200 again in order to access data when a row of the first bank to be accessed is closed to be refreshed. Therefore, the writing/reading commands need to be provided to the memory device 200 after the row opens, and the writing/reading commands are delayed by a predetermined time according to a specification of the row. That is, when a bank currently accessed matches a bank to be refreshed, a performance of the memory system may decrease according to a time loss as described above.

Furthermore, when access corresponding to the first bank is sustained, a refresh standby state may be maintained until the access corresponding to the first bank ends, and thus stability in retaining data may be deteriorated. However, according to the above described embodiment, the refresh operation may be efficiently performed by preferentially refreshing banks which do not have opened rows for data access, and thus stability in retaining data may be improved.

In other words, according to an embodiment of the inventive concept, a next access sequence is predicted by recognizing a bank requested for access (for example, a target bank), and, therefore, a probability of matching the bank currently accessed with the bank to be refreshed may decrease by preferentially refreshing banks not to be accessed.

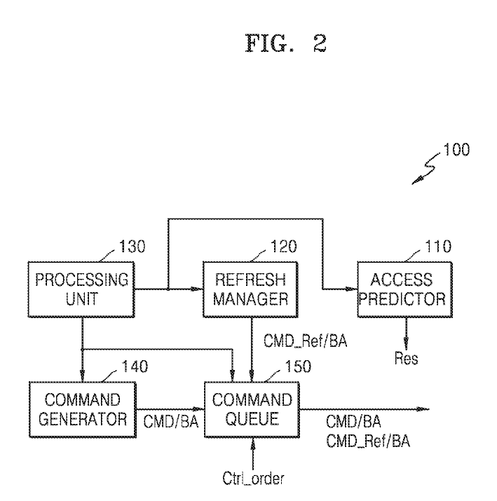

FIG. 2 is a block diagram illustrating the memory controller in FIG. 1, according to an embodiment of the inventive concept.

As illustrated in FIG. 2, the memory controller 100 includes an access predictor 110, a refresh manager 120, a processing unit 130, a command generator 140, and a command queue 150. Even though not shown in FIG. 2, the memory controller 100 may further include other various functional blocks to control the memory device 200. Furthermore, the functional blocks of the memory controller 100 in FIG. 2 and a signal transceiving relation thereof are only examples, and various functions according to embodiments of the inventive concept may be performed even if the various functional blocks and the signal transceiving relation are changed.

Referring to FIGS. 1 and 2, the processing unit 130 may control a general operation of the memory controller 100, and thus may control the various functional blocks included in the memory controller 100. As described above, the access predictor 110 may select at least one bank predicted to be accessed next with reference to the bank requested for access received from the host, and may generate a selecting result (or a prediction result Res) thereof. The refresh manager 120 may manage a refresh operation so that every memory cell of the memory cell array 210 in a refresh period may be refreshed and, for example, may generate a refresh command CMD_Ref and a bank address BA by determining refresh timings. Furthermore, the command generator 140 may generate a command CMD according to a request for access received from the host and a bank address BA for instructing a bank to be accessed.

A refresh command CMD_Ref/bank address BA from the refresh manager 120 and a command CMD/bank address BA from the command generator 140 may be stored in the command queue 150. The command queue 150 may store the refresh command CMD_Ref/bank address BA and the command CMD/bank address BA according to an order of input information. The refresh command CMD_Ref/bank address BA or the command CMD/bank address BA may be provided to the memory device 200 via an interface in an order of information stored in the command queue 150.

Meanwhile, a refresh operation of the memory device 200 may be controlled according to the prediction result Res of the access predictor 110. For example, referring to the memory device 200 including the banks as described above, refresh orders of respective banks may be controlled to be changed based on an access prediction operation.

An order control signal Ctrl_order to change the storing order of the information stored in the command queue 150 may be generated based on the prediction result Res of the access predictor 110. For example, the processing unit 130 may generate the order control signal Ctrl_order based on the prediction result Res. Alternatively, in another exemplary embodiment, the refresh manager 120 may generate the order control signal Ctrl_order based on the prediction result Res. The refresh orders of respective banks may be changed as the storing order of the information stored in the command queue 150 is changed according to the order control signal Ctrl_order.

For example, if a certain bank (for example, a first bank) needs to be refreshed relatively later according to the access prediction result, a storing position of information about the refresh command CMD_Ref and the bank address BA to designate the first bank stored in the command queue 150 may be changed and the information output in a later order. Accordingly, other banks rather than the first bank may be refreshed first.

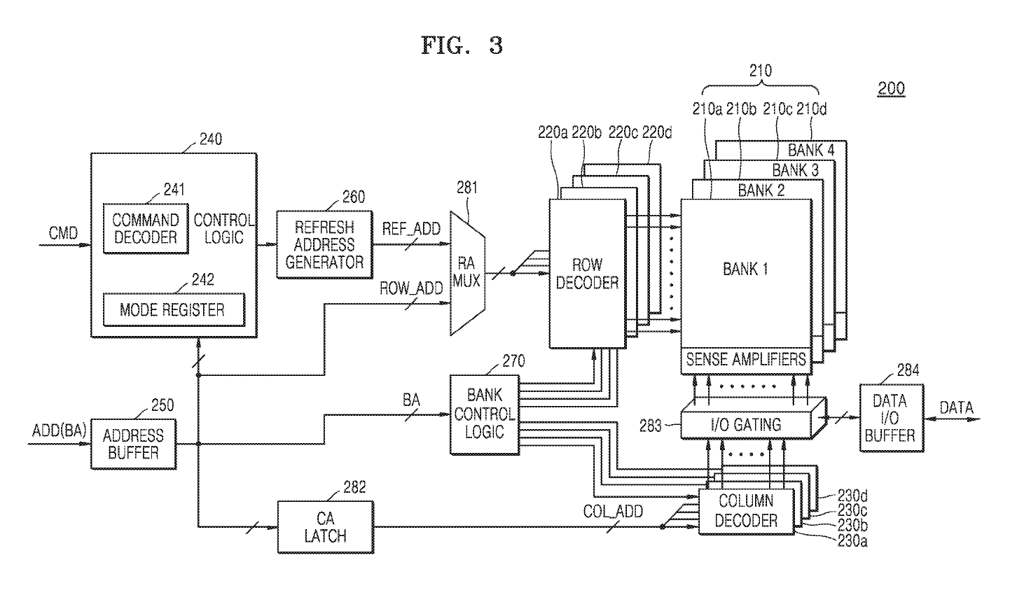

FIG. 3 is a block diagram of the inventive concept a memory device in FIG. 1 according to embodiment of the inventive concept. The memory device 200 of FIG. 3 is only an exemplary embodiment and a configuration of the memory device used in the inventive concept may be variously changed. Furthermore, even though first to fourth banks 210a to 210d as a plurality of banks are illustrated in FIG. 3, more banks may be generated in the memory device 200.

The memory device 200 may include at least one memory chip. The memory device 200 in FIG. 3 illustrates a configuration of any one of the memory chips. The memory device 200 may include a memory cell array 210 including the first to fourth banks 210a to 210d, row decoders 220a to 220d and column decoders 230a to 230d respectively disposed corresponding to the banks, a control logic 240, an address buffer 250, a refresh address generator 260, a bank control logic 270, a row address selector 281, a column address latch 282, an input/output gating circuit 283, and a data input/output buffer 284. Furthermore, sense amplifiers may be included corresponding to the first to fourth banks 210a to 210d.

Meanwhile, the memory device 200 may be a DRAM such as Double Data Rate Synchronous Dynamic Random Access Memory (DDR SDRAM), Low Power Double Data Rate (LPDDR) SDRAM, Graphics Double Data Rate (GDDR) SDRAM, or Rambus Dynamic Random Access Memory (RDRAM), or the like. However, in other embodiments of the inventive concept, any other memory devices that need a refresh operation may also be used as the memory device 200. For example, since a resistive memory device is a type of nonvolatile memory device that performs a refresh operation, the memory device 200 according to an embodiment of the inventive concept may be nonvolatile memory.

The control logic 240 may control a general operation of the memory device 200 and includes, e.g., a command decoder 241 and a mode resistor 242. The control logic 240 may generate control signals so as to perform a write or read operation according to a command CMD received from the memory controller 100. Furthermore, the control logic 240 may generate control signals for a refresh operation for the first to fourth banks 210a to 210d according to a refresh command received from the memory controller 100. Alternatively, the control logic 240 may generate control signals for the refresh operation for the first to fourth banks 210a to 210d in a self refresh mode. The mode resistor 242 may include a plurality of resistors storing information for setting an operation environment of the memory device 200.

The address buffer 250 may receive an address ADD received from the memory controller 100. As described above, the address ADD may include a bank address BA. Furthermore, the address ADD may include a row address ROW_ADD to instruct rows of the memory cell array 210 and a column address COL_ADD to instruct columns of the memory cell array 210. The row address ROW_ADD may be provided to the row decoders 220a to 220d via the row address selector 281, and the column address COL_ADD may be provided to the column decoders 230a to 230d via the column address latch 282. Furthermore, the bank address BA may be provided to the bank control logic 270.

The bank control logic 270 may generate bank control signals responding to the bank address BA. Furthermore, a row decoder corresponding to the bank address BA from among the first to fourth row decoders 220a to 220d may be activated, and a column decoder corresponding to the bank address BA from among the first to fourth column decoders 230a to 230d may be activated, responding to the bank control signals.

The refresh address generator 260 may generate a refresh address REF_ADD to select a row to be refreshed from the memory cell array 210. For example, the refresh address generator 260 may include a counter (not shown) and may sequentially generate the refresh address REF_ADD so that a value thereof increases according to a counting operation of the counter. The row address selector 281 may be a multiplexer. The row address selector 281 may output the row address ROW_ADD provided from the memory controller 100 during data access, and may furthermore output the refresh address REF_ADD generated by the refresh address generator 260 during the refresh operation. Even though the exemplary embodiment of FIG. 3 illustrates that the refresh address REF_ADD instructing the row to be refreshed is generated in the memory device 200, the refresh address REF_ADD may also be provided from the memory controller 100 according to embodiments of the inventive concept.

According to embodiments of the inventive concept, memory cells corresponding to any one of the rows of first to fourth banks BANK 1 to BANK 4 may be sequentially refreshed, and memory cells corresponding to another row of the first to fourth banks BANK 1 to BANK 4 may be sequentially refreshed next. When each of the first to fourth banks BANK 1 to BANK 4 includes A rows, respective first rows of the first to fourth banks BANK 1 to BANK 4 may be refreshed and respective second rows may be refreshed next. The entire A rows of the first to fourth banks BANK 1 to BANK 4 may be refreshed according to the sequential operations.

According to an embodiment of the inventive concept, a bank to be refreshed may be selected by the bank address BA provided from the memory controller 100. Furthermore, a bank requested for access is determined as described above, and at least one bank predicted to be accessed next is selected. Moreover, refresh orders corresponding to the banks BANK 1 to BANK 4 may be changed based thereon. Accordingly, the refresh orders of respective banks in any one of the rows of the first to fourth banks BANK 1 to BANK 4 may be different from those of respective banks in other rows. For example, while a refresh operation is sequentially performed in an order of the first bank BANK 1 to the fourth bank BANK 4 corresponding to the first row, a refresh operation may performed in an order of the first bank BANK 1, the third bank BANK 3, the fourth bank BANK 4, and the second bank BANK 2 corresponding to the second row.

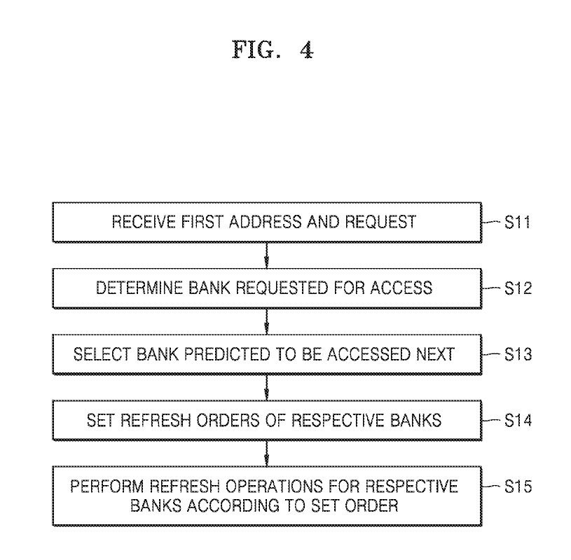

FIG. 4 is a flowchart illustrating an operating method of a memory system, according to an embodiment of the inventive concept.

First, the memory system may receive a request for data access and a first address representing memory cells requested for access from a host (S11). An address analyzing (or decoding) operation is performed according to the first address received from the host in order to select the memory cells, and a bank requested for access may be determined according to the result (S12). Furthermore, a prediction operation capable of being realized in various ways based on the bank requested for access may be performed, and at least one bank predicted to be accessed next may be selected as the result (S13).

Refresh orders of respective banks may be set based on the determination result of the bank requested for access and/or the bank prediction result (S14). The refresh order corresponding to the bank requested for access may be changed to be the same as or similar to the exemplary embodiment described above. Alternatively, the refresh order corresponding to at least one bank predicted to be accessed next may be changed. Alternatively, the refresh orders corresponding to the bank requested for access and at least one bank predicted to be accessed next may be changed. In an example of the changed refresh order, the refresh orders of the bank requested for access and/or at least one bank predicted to be accessed next may be set to be relatively later than those of other banks.

An operation environment of the memory system may be set so that the refresh operation may be performed at least once corresponding to every memory cell included in a memory cell array according to a predetermined period. The memory system senses whether the refresh timing has come, and performs refresh operations for respective banks according to the set order (S15). For example, bank addresses may be generated so that banks may be selected according to the set order of respective banks during the refresh operation.

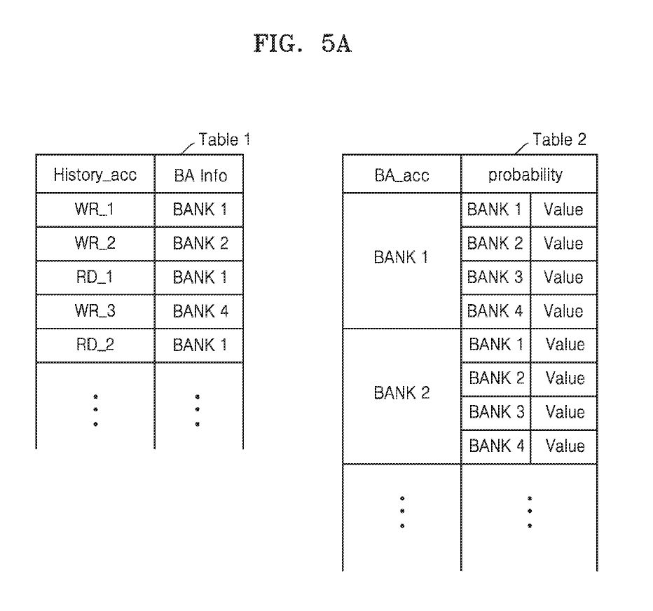

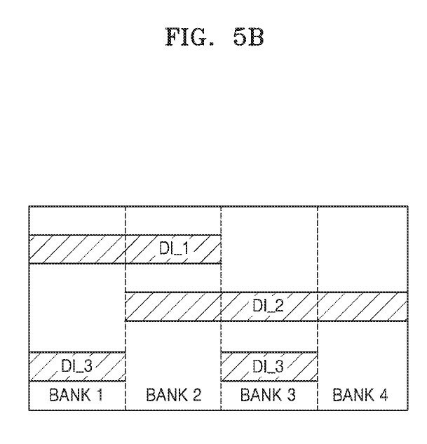

FIGS. 5A and 5B are block diagrams illustrating an access prediction operation, according to an embodiment of the inventive concept.

FIG. 5A illustrates an example according to an embodiment of the inventive concept, in which a memory controller may store at least one table, for example, a first table Table 1 and a second table Table 2. The first table Table 1 may store information related to an access history whenever a request and an address are received form a host. For example, types of the request and bank information corresponding thereto may be stored. The information stored in the first table Table 1 may be periodically updated.

Meanwhile, an access pattern of each bank may be analyzed by referring to the information stored in the first table Table 1. A bank having a higher probability of being accessed next and a bank having a lower probability of being accessed may be analyzed. For example, a probability of access of each bank according to the analyzing result may be calculated, and information related thereto may be stored in the second table Table 2. Furthermore, as the information stored in the first table Table 1 is periodically updated, the information stored in the second table Table 2 may also be updated.

For example, when a request for access corresponding to the first bank BANK 1 is received, a next access sequence may be predicted with reference to the second table Table 2. When the first bank BANK 1 is requested for access, a bank having a higher probability of being accessed next may be predicted based on information stored in the second table Table 2, and at least one bank may be selected as a bank predicted to be accessed according to the prediction result. Similarly, when the second bank BANK 2 is accessed, at least one bank predicted to be accessed based on a probability of access corresponding to each of the first to fourth banks BANK 1 to BANK 4 may be selected. The same operation as described above will be performed in each of the third and fourth banks BANK 3 and BANK 4.

In an embodiment of the inventive concept, when a request for access corresponding to any one of the banks is received, different banks may be selected according to types of the request in predicting a bank to be accessed next. For example, referring to the information stored in the first table Table 1, a bank predicted to be accessed next when writing WR corresponding to the first bank BANK 1 is requested and a bank predicted to be accessed next when reading RD corresponding to the first bank BANK 1 is requested may be different.

Meanwhile, as illustrated in FIG. 5B, status information related to a storage state of data information may be stored in the memory controller. For example, first data information DI 1 may be stored in two banks (for example, first and second banks), and second data information DI 2 may be stored in second to fourth banks BANK 2 to BANK 4. Furthermore, third data information DI 3 may be stored in the first bank BANK 1 and the third bank BANK 3.

Referring to a position of memory cells requested for access, the bank corresponding to the position may be determined, and at least one bank predicted to be accessed next may be determined. For example, when the first bank BANK 1 is requested for access and data corresponding thereto falls under third data information DI 3, it is possible to predict the third bank BANK 3 to be accessed next.

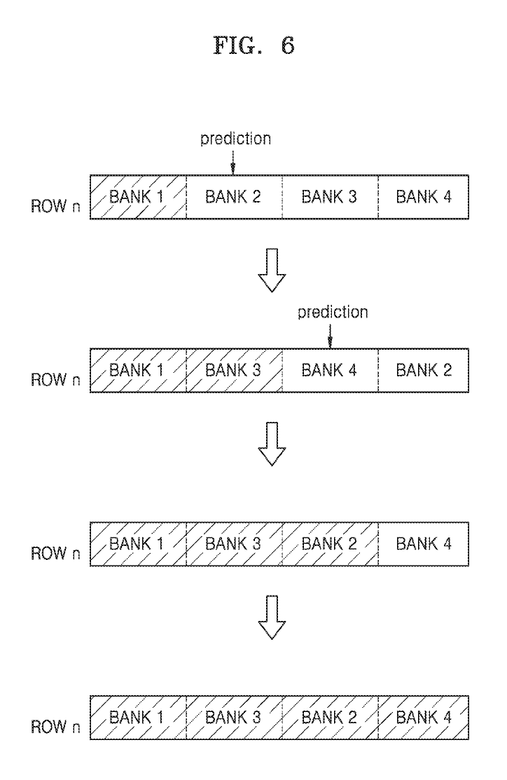

FIG. 6 is a block diagram of setting refresh orders of respective banks, according to an embodiment of the inventive concept. FIG. 6 illustrates an example of changing refresh orders of respective banks when a refresh operation corresponding to rows (for example, one row) of a plurality of banks is performed. Furthermore, one of the banks predicted to be accessed next is selected and refreshed last in FIG. 6. However, embodiments of the inventive concept are not limited thereto and a refresh order of the selected bank to be accessed may be arbitrarily changed. Meanwhile, in embodiments described below, the selected bank by being predicted to be accessed next may be referred to as an access-predicted bank for convenience of explanation.

Referring to FIG. 6, as the first to fourth banks BANK 1 to BANK 4 are set to be sequentially refreshed, a row ROW n of the first bank BANK 1 is refreshed. Furthermore, the second bank BANK 2 may be selected as the access-predicted bank by analyzing an address received from a host.

According to the prediction result, an order of the refresh operation is changed so that the second bank BANK 2 is refreshed last and a row ROW n of the third bank BANK 3 is refreshed accordingly. Next, a request and an address are received from the host again, and the prediction operation may be performed again by analyzing the received address. The fourth bank BANK 4 may be selected as the access-predicted bank according to a corresponding prediction result, and an order of the refresh operation is changed so that the fourth bank BANK 4 is refreshed last.

As the refresh orders of respective banks are changed again, a row ROW n of the second bank BANK 2 is refreshed according to the currently changed order. Next, a row ROW n of the fourth bank BANK 4 that is set to be refreshed last is refreshed.

According to an embodiment of the inventive concept, a refresh order of remaining banks that are not refreshed yet is changed so that the refresh operations of respective banks are performed according to the changed order during the refresh operations for the banks BANK 1 to BANK 4. Therefore, it is possible to reduce a probability of matching a bank to be accessed with a bank to be refreshed, thereby improving the performance of the memory system.

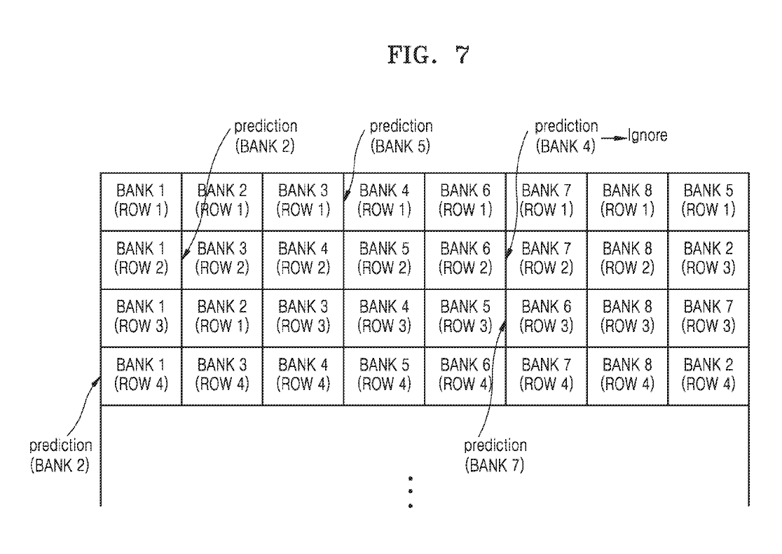

FIGS. 7 to 10 are tables illustrating refresh orders of respective banks, according to an embodiment of the inventive concept. Even though FIGS. 7 to 10 illustrate examples of changing a refresh order once in a row for convenience of explanation, the refresh order may be changed twice or more during a refresh operation for each row of a plurality of banks as described with regard to the embodiment of FIG. 6. Furthermore, examples of setting a refresh order corresponding to first to eighth banks BANK 1 to BANK 8 are described with regard to embodiments of FIGS. 7 to 10.

The embodiment of FIG. 7 describes an example in which a basic refresh order of each of the banks is already set and the refresh order is changed under the setting state. For example, the basic refresh order is set to be sequentially refreshed from the first bank BANK 1 to the eighth bank BANK 8.

Refresh operations corresponding to first rows ROW 1 according to the previously set order is performed, and a fifth bank BANK 5 may be selected as an access-predicted bank at a certain point in time according to a result of analyzing an address received from a host. Accordingly, the refresh order corresponding to the first row ROW 1 is changed so that the fifth bank BANK 5 is refreshed last.

Refresh operations corresponding to second rows ROW 2 of the first to eighth banks BANK 1 to BANK 8 may also be performed according to the previously set order. Accordingly, the refresh operation may be performed from the second row ROW 2 of first bank BANK 1. As the second bank BANK 2 may be selected as an access-predicted bank at a certain point in time according to a result of analyzing an address received from a host, an order of the refresh operation is changed so that the second bank BANK 2 is refreshed last.

Meanwhile, the fourth bank BANK 4 may be selected as an access-predicted bank according to the prediction result during the refresh operation corresponding to the second row ROW 2. As the second row ROW 2 of the fourth bank BANK 4 is already refreshed, the fourth bank BANK 4 is not selected anymore in the refresh operation corresponding to the second row ROW 2. Accordingly, the refresh order is not changed regardless of the prediction result, and the prediction result may be ignored.

Third and fourth rows ROW 3 and ROW 4 may also be refreshed in the same manner as or a similar manner to that described above. As the seventh bank BANK 7 may be selected as an access-predicted bank according to the prediction result during the refresh operation corresponding to the third row ROW 3, an order of the seventh bank BANK 7 is changed so that the seventh bank is refreshed last. Furthermore, as the second bank BANK 2 may be selected as an access-predicted bank according to the prediction result during the refresh operation corresponding to the fourth row ROW 4, an order of the second bank BANK 2 is changed so that the second bank is refreshed last.

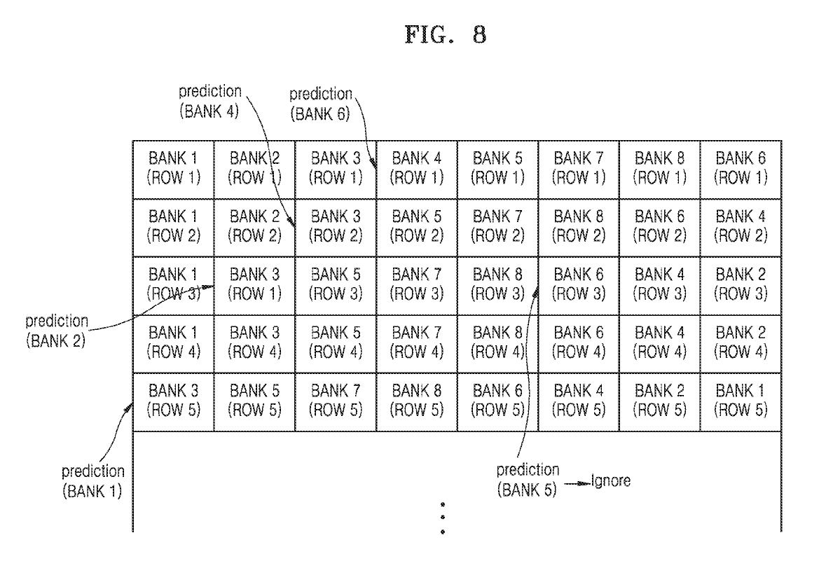

Meanwhile, the embodiment of FIG. 8 describes an example in which a basic refresh order of each of the banks is not previously set and a refresh order of each of the banks set in a previous row also affects a refresh order corresponding to a next row.

The refresh order is set to be sequentially refreshed from the first bank BANK 1 to the eighth bank BANK 8. Accordingly, the refresh operation may be sequentially performed from a first row ROW 1 of the first bank BANK 1.

The sixth bank BANK 6 may be selected as an access-predicted bank at a certain point in time according to a result of analyzing an address received from a host. Accordingly, the refresh order corresponding to a first row ROW 1 of the sixth bank BANK 6 is changed so that the sixth bank is refreshed last.

Next, the refresh operations corresponding to second rows ROW 2 of the first to eighth banks BANK 1 to BANK 8 may be performed according to the finally changed refresh order. The fourth bank BANK 4 may be selected as an access-predicted bank at a certain point in time according to a result of analyzing an address received from a host. Accordingly, the refresh order corresponding to the second row ROW 2 of the fourth bank BANK 4 is changed so that the fourth bank is refreshed last. As the sixth bank BANK 6 is already set to be refreshed last, the refresh orders corresponding to the second row ROW 2 is hanged so that the fourth bank BANK 4 is refreshed after the sixth bank BANK.

The third to fifth rows ROW 3 to ROW 5 may also be refreshed in the same manner as or a similar manner to that described above. The second bank BANK 2 may be selected as an access-predicted bank at a certain point in time according to a result of analyzing an address received from a host. Accordingly, the refresh orders corresponding to the third row ROW 3 is changed so that the second bank BANK 2 is refreshed after the sixth and fourth banks BANK 6 and BANK 4 are refreshed. Furthermore, similar to a case described above, when a bank (for example, fifth bank BANK 5) in which the third row ROW 3 thereof is refreshed is predicted to be accessed next during the refresh operation corresponding to the third row ROW 3, a prediction result corresponding thereto may be ignored.

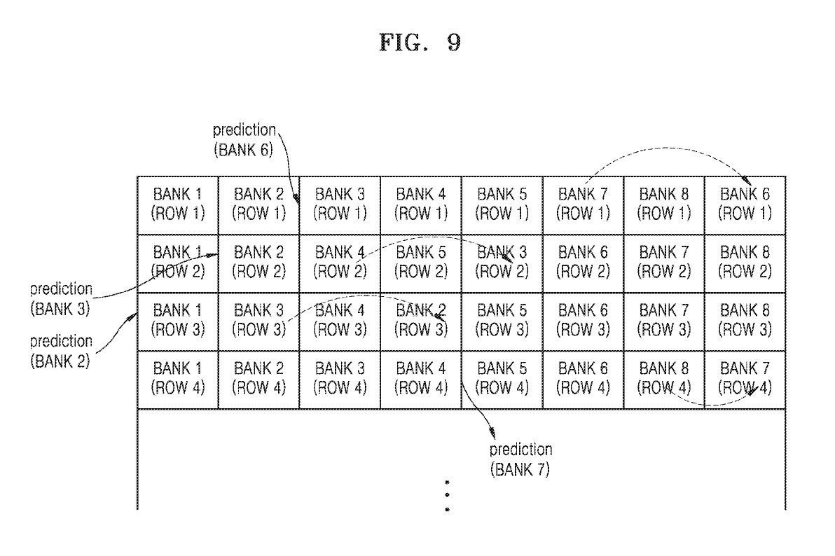

Meanwhile, the embodiment of FIG. 9 describes an example in which a refresh operation for a bank predicted to be accessed next is delayed according to a constant interval without the bank being refreshed last. Even though the exemplary embodiment of FIG. 9 illustrates an example of adjusting a refresh order of a bank by delaying a refreshing operation twice, an exemplary embodiment is not limited thereto and may be variously changed. Furthermore, an example of previously setting a basic refresh order of each of the banks is reflected in the exemplary embodiment of FIG. 9 similar to the embodiment of FIG. 7. However, the present embodiment may also include features described with regard to the exemplary embodiment of FIG. 8.

A sixth bank BANK 6 may be selected as an access-predicted bank at a certain point in time according to a result of analyzing an address received from a host while refreshing the first row ROW 1. Accordingly, a refresh operation of a first row ROW 1 of the sixth bank BANK 6 may be delayed twice (or two of other banks are refreshed first), and, thus, the first row ROW 1 of the sixth bank BANK 6 may be refreshed after an eighth bank BANK 8 is refreshed.

Similarly, a refresh order of a third bank BANK 3 may be adjusted according to the access prediction result during the refresh operation corresponding to a second row ROW 2, and a second row ROW 2 of the third bank BANK 3 may be refreshed after a fifth bank BANK 5 is refreshed as the refresh operation is delayed twice. Furthermore, a third row ROW 3 of a second bank BANK 2 may be refreshed after a fourth bank BANK 4 is refreshed during the refresh operation corresponding to a fourth row ROW 4.

Meanwhile, as described regarding fourth row ROW 4, it is not possible to delay twice a refresh operation of a seventh bank BANK 7 when the refresh order of the seventh bank BANK 7 needs to be adjusted according to the access prediction result. Therefore, a fourth row ROW 4 of the seventh bank BANK 7 may be refreshed after a fourth row ROW 4 of an eighth bank BANK 8 is refreshed.

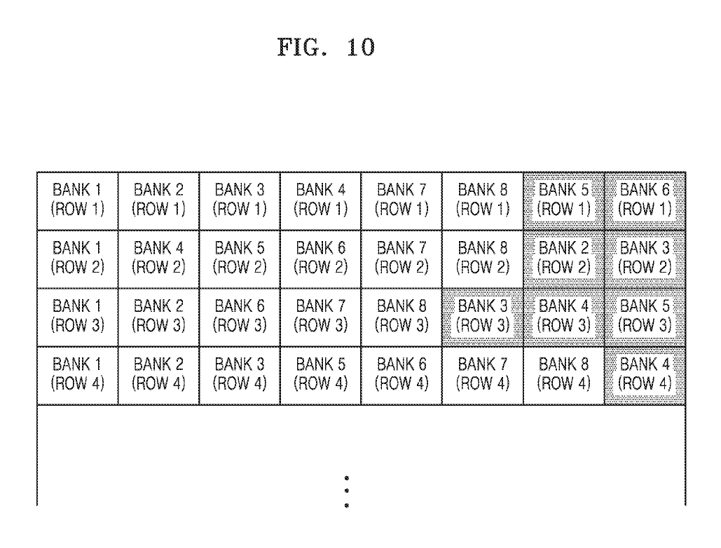

Meanwhile, the embodiment of FIG. 10 describes an example of changing refresh orders of at least two banks. An example of previously setting the basic refresh order of each of the banks is reflected in the embodiment of FIG. 10 similar to the embodiment of FIG. 7. However, the present embodiment may include features described with regard to the exemplary embodiment of FIG. 8.

As illustrated in FIG. 10, the refresh orders of at least two of the banks may be changed in performing a refresh operation for one row. That is, the refresh orders may be adjusted by selecting at least two of the banks according to the prediction result that is the same as or similar to the embodiment described above. Alternatively, a refresh order of a bank currently requested for access may be adjusted so that the bank currently requested for access is refreshed relatively later. Refresh orders of two banks may be changed for first and second rows ROW 1 and ROW 2, refresh orders of three banks may be changed for a third row ROW 3, and a refresh order of one bank may be changed for a fourth row ROW 4.

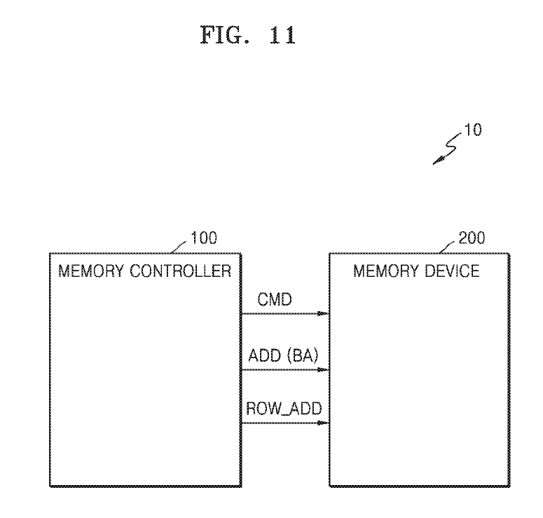

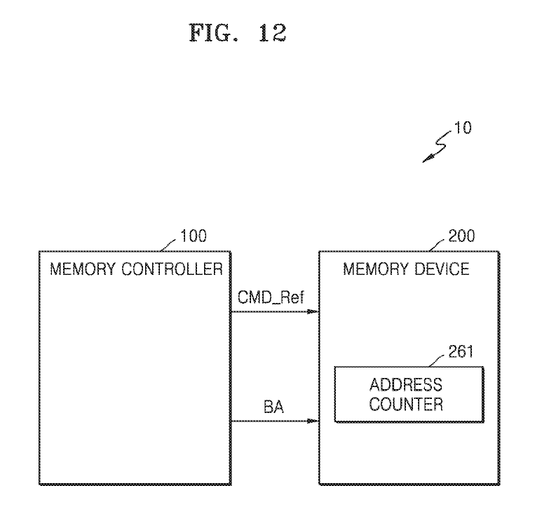

FIGS. 11 and 12 are block diagrams illustrating signal transceiving between a memory controller and a memory device, according to an embodiment of the inventive concept.

The embodiment of FIG. 11 illustrates an example in which a memory controller 100 provides a refresh address as a row address ROW_ADD to a memory device 200 during a refresh operation for a memory system 10. While the refresh operation is performed, the memory controller 100 may generate and provide a bank address BA to the memory device 200 so as to match refresh orders of respective banks capable of being refreshed according to the embodiment described above via a refresh command CMD_Ref commanding the refresh operation. Furthermore, the memory controller 100 may generate and provide a row address ROW_ADD to the memory device 200 in order to instruct a row of each of the banks to be refreshed.

Meanwhile, in an embodiment of FIG. 12, an address counter 261 installed in the memory device 200 may generate a refresh address to instruct a row of each of the banks to be refreshed during a refresh operation of a memory system 10. The address counter 261 may be included in the refresh address generator 260 of the memory device 200 of FIG. 3.

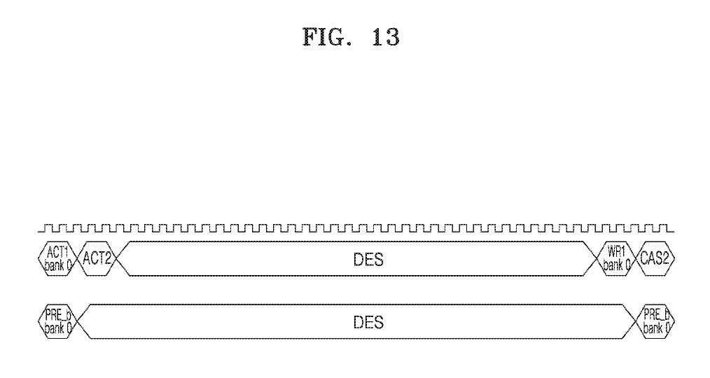

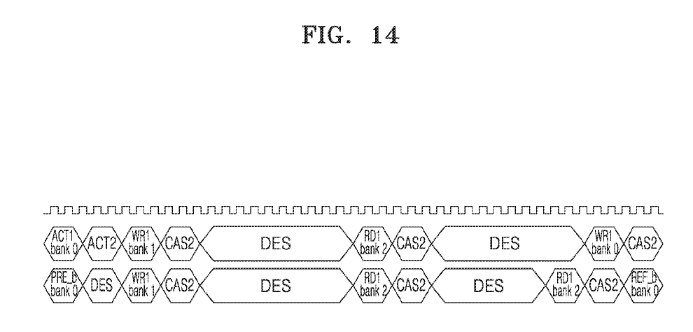

FIGS. 13 and 14 are waveform diagrams illustrating signals in an example of a refresh operation, according to an embodiment of the inventive concept.

FIG. 13 illustrates an example of representing memory operation timing in a bank BANK 0. Various commands ACT1 and ACT2 are provided to the bank BANK 0, and a row of the bank BANK 0 opens accordingly. A write command and column information WR1 and CAS2 may be provided when the row opens through a predetermined time section DES. Furthermore, the opened row of the bank BANK 0 closes through the predetermined time section DES when a command PRE_b to close the opened row is provided. When an access operation matches a refresh operation for the bank BANK 0, the refresh operation is delayed during a long section, or a time loss may occur due to stopping of the access operation for the BANK 0 and repeating of the opening and closing processes of the row.

On the contrary, as illustrated in FIG. 14, a multi bank structure may be efficiently used by not matching a bank in which an access operation is performed with a bank in which a refresh operation is performed. That is, various commands WR1, CAS2, RD1, and CAS2 corresponding to other banks may be properly performed between a predetermined time section DES to open a row of a bank BANK 0. When the various commands WR1, CAS2, RD1, and CAS2 corresponding to other banks of FIG. 14 are replaced via a refresh command, it can be seen that other banks BANK 1 and BANK 2 may be efficiently refreshed without interrupting the access operation for the bank BANK 0.

Hereinafter, various examples of adjusting refresh orders of respective banks according to embodiments of the inventive concept will be described. The refresh orders of respective banks will be described with regard to a row unit for convenience of explanation. However, the refresh orders may be changed while performing a refresh operation for any one row as described above in the embodiments of the inventive concept.

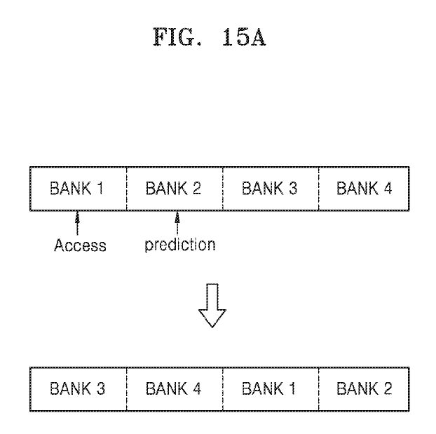

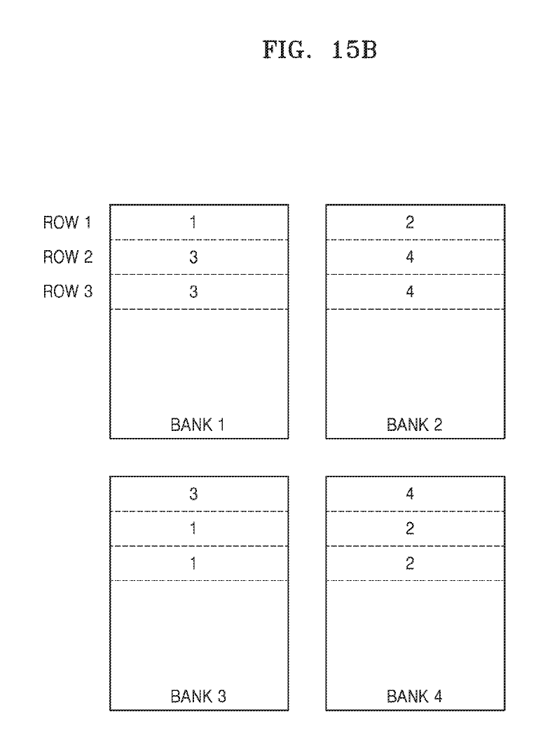

FIGS. 15A and 15B are block diagrams illustrating setting refresh orders of respective banks, according to another embodiment of the inventive concept.

Referring to FIGS. 15A and 15B, first to fourth banks BANK 1 to BANK 4 are set to be sequentially refreshed, and thus first rows ROW 1 of the first to fourth banks BANK 1 to BANK 4 are sequentially refreshed from the first bank BANK 1 to the fourth bank BANK 4.

When a request and an address corresponding thereto are received from a host, a bank requested for access is determined by analyzing the address, and furthermore, at least one bank predicted to be accessed next is selected. For example, a bank currently requested for access may correspond to the first bank BANK 1, and a bank predicted to be accessed next may correspond to the second bank BANK 2. The refresh orders of respective banks may be changed in a next refresh operation according to the determination and the prediction result.

In embodiments of the inventive concept, the bank currently requested for access and the bank predicted to be accessed next may be set to be refreshed later than other banks. Furthermore, in an embodiment of the inventive concept, the bank currently requested for access (for example, BANK 1) or the bank predicted to be accessed next (for example, BANK 2) may be set to be refreshed last. In an embodiment as shown in FIG. 15A, the second bank BANK 2 may be set to be refreshed after the first bank BANK 1 is refreshed when the first and second banks BANK 1 and BANK 2 are set to be refreshed relatively later.

Accordingly, as illustrated in FIG. 15B, refresh operations may be performed in an order of the third bank BANK 3, the fourth bank BANK 4, the first bank BANK 1, and the second bank BANK 2 after second rows ROW 2 of the first to fourth banks BANK 1 to BANK 4. The bank currently requested for access and the bank predicted to be accessed next may be determined according to an address analysis result when the request and the address are received from the host again. As a result, the refresh orders of respective banks may be changed again.

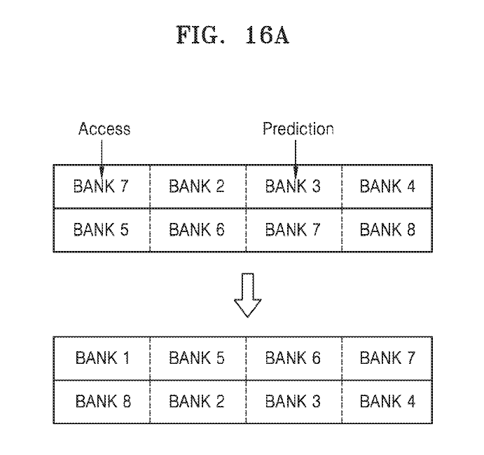

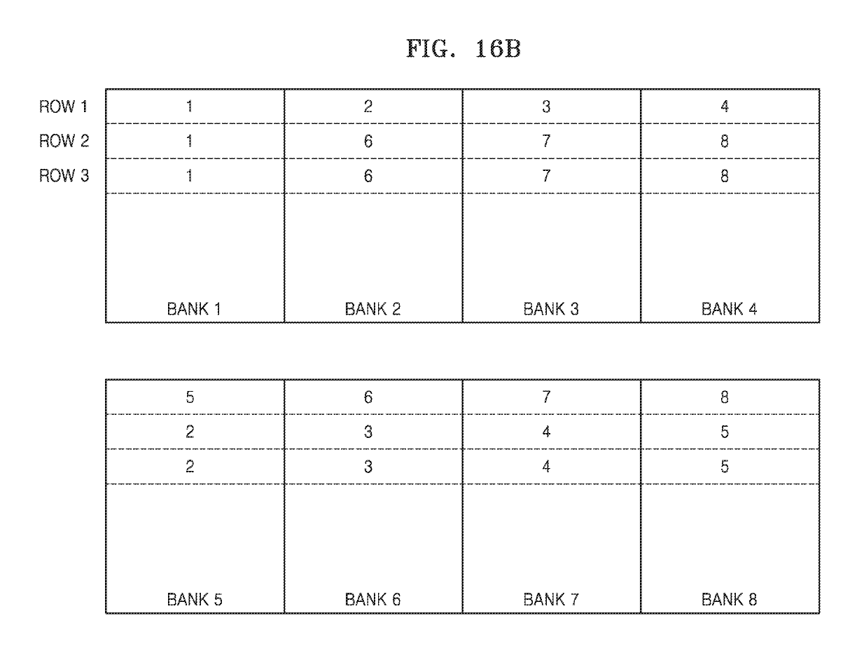

FIGS. 16A and 16B are block diagrams illustrating setting refresh orders of respective banks, according to another embodiment of the inventive concept. FIGS. 16A and 16B illustrate an example in which a memory device includes eight banks BANK 1 to BANK 8.

Referring to FIGS. 16A and 16B, as the first to eighth banks BANK 1 to BANK 8 are set to be sequentially refreshed, first rows ROW 1 of the first to eighth banks BANK 1 to BANK 8 are sequentially refreshed from the first bank BANK 1 to the eighth bank to BANK 8. Next, a bank requested for access may be determined by analyzing an address from a host, and at least one bank predicted to be accessed next may be selected. For example, the bank currently requested for access may correspond to the first bank BANK 1, and the access-predicted bank may correspond to the third bank BANK 3.

In an embodiments of the inventive concept, at least two banks including the access-predicted bank (for example, BANK 3) may be set to be refreshed later than other banks. For example, when data information of a specific unit is written in at least two banks, the probability that at least two banks are physically or logically adjacent to each other may be high. Accordingly, when access corresponding to any one of the banks is requested, the probability that other banks physically or logically adjacent to the bank requested for access may also be high. Therefore, as illustrated in FIG. 16A, when the third bank BANK 3 is predicted to be accessed next, at least one bank (for example, BANK 2 and BANK 4) adjacent to the third bank BANK 3 may be selected together, and the second to fourth banks BANK 2 to BANK 4 may be set to be refreshed later than other banks.

FIG. 16A illustrates a refresh operation in an order of the second bank BANK 2, the third bank BANK 3, and the fourth bank BANK 4 according to another embodiment, but the embodiments are not limited thereto. That is, the refresh orders of the selected banks BANK 2 to BANK 4 may be arbitrarily set. For example, the third bank BANK 3 predicted to be accessed next may be refreshed after the second and fourth banks BANK 2 and BANK 4 adjacent to the third bank BANK 3 are refreshed. On the contrary, the second and fourth banks BANK 2 and BANK 4 may be refreshed after the third bank BANK 3 is refreshed.

Accordingly, as illustrated in FIG. 16B, after second rows ROW 2 of the first to eighth banks BANK 1 to BANK 8, the second to fourth banks BANK 2 to BANK 4 are refreshed relatively later than other banks. The bank predicted to be accessed next and a bank adjacent thereto may be determined by receiving again the request and the address received from the host later, and the refresh orders of respective banks based thereon may be changed again.

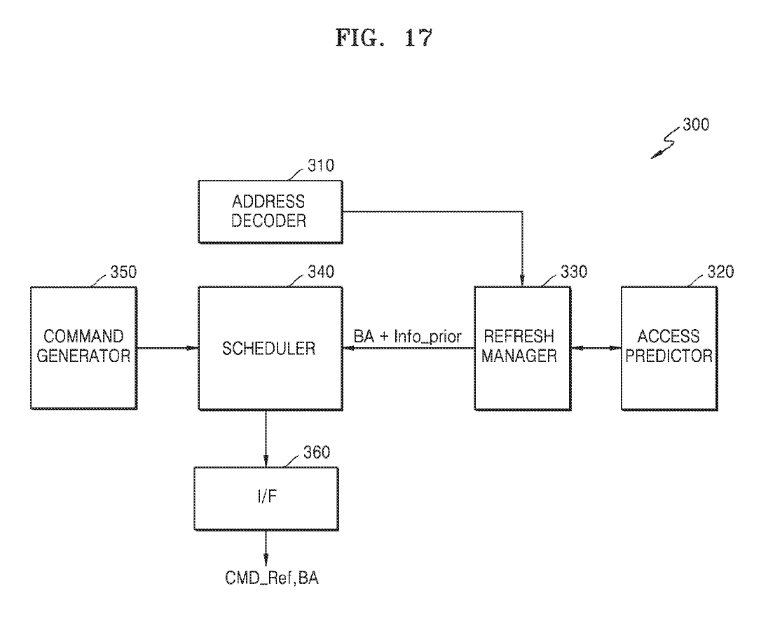

FIG. 17 is a block diagram illustrating a memory controller, according to another embodiment of the inventive concept. FIG. 17 illustrates an example of setting refresh orders of respective banks based on priority information Info_prior.

As illustrated in FIG. 17, a memory controller 300 includes an address decoder 310, an access predictor 320, a refresh manager 330, a scheduler 340, a command generator 350, and an interface unit 360.

The address decoder 310 may receive an address from an external device and perform a decoding operation thereof. The memory controller 300 may manage memory operations for respective banks according to the address received from the external device (for example, a host), and a bank requested for access may be determined by decoding the address received from the host. Furthermore, the address decoding result may be provided to the access predictor 320, and at least one bank predicted to be accessed next may be selected by the access predictor 320 via the same or similar method to the methods described with regard to the above exemplary embodiments.

The refresh manager 330 may manage a refresh operation of a memory device based on the bank selecting result from the access predictor 320. The refresh manager 330 may generate a bank address BA representing a bank to be refreshed via a refresh command, and may provide the bank address BA to the scheduler 340. Furthermore, the priority information Info_prior representing whether a bank corresponding the refresh command needs to be preferentially refreshed may further be provided to the scheduler 340 based on information about the bank currently requested for access and/or at least one bank predicted to be accessed next.

The command generator 350 generates a command corresponding to various requests provided from the host. The scheduler 340 may perform scheduling corresponding to various commands from the command generator 350 and the refresh command provided from the refresh manager 330, and may provide the memory device with the command and the address to control the memory device via the interface unit 360.

The scheduler 340 may determine the refresh orders of respective banks based on the priority information Info_prior further provided in correspondence with each of the bank addresses BA, and may control the banks to be refreshed according to the determined order. The memory operations and the refresh operation may be scheduled in an order, in order not to match the bank to be refreshed with the bank in which at least one row is opened to be accessed, by using the same method as or a similar method to the method described in the exemplary embodiment above.

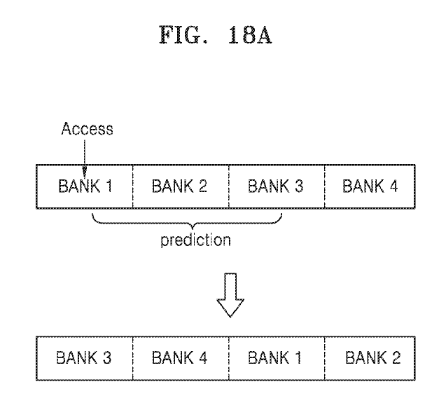

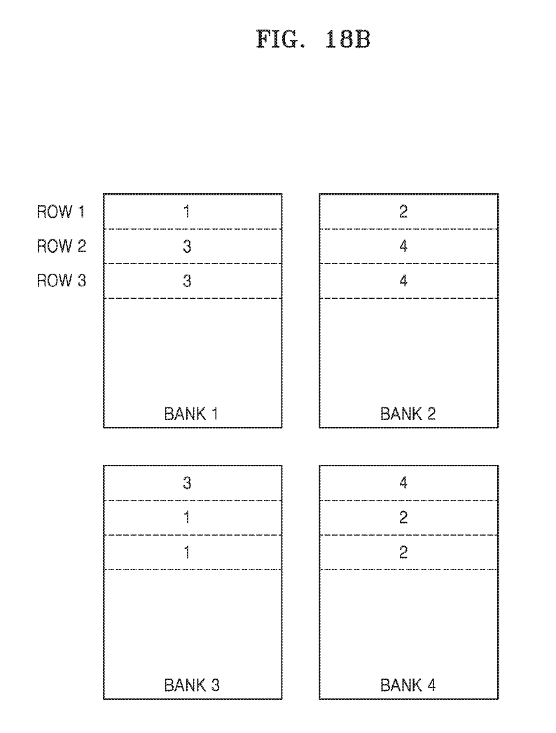

FIGS. 18A and 18B are block diagrams illustrating another example of setting refresh orders of respective banks, according to an embodiment of the inventive concept. FIGS. 18A and 18B illustrate an example of setting the refresh orders of respective banks according to a joint electron device engineering council (JEDEC) standard.

Referring to FIGS. 18A and 18B, as first to fourth banks BANK 1 to BANK 4 are set to be sequentially refreshed, first rows ROW 1 of the first to fourth banks BANK 1 to BANK 4 are sequentially refreshed from the first bank BANK 1 to the fourth bank BANK 4. Next, a bank requested for access may be determined by analyzing an address from a host, and at least one bank predicted to be accessed next may be selected. For example, the first to third banks BANK 1 to BANK 3 may be predicted to be accessed next.

When the banks predicted to be accessed next are refreshed relatively later, the fourth bank BANK 4 may be refreshed first, and the remaining banks BANK 1 to BANK 3 may be refreshed next in a refresh operation corresponding to second rows ROW 2 of the first to fourth banks BANK 1 to BANK 4. The bank most recently refreshed does not entirely match the JEDEC standard in order not to perform the refresh operation continuously. That is, as a first row ROW 1 of the fourth bank BANK 4 is refreshed and a second row ROW 2 of the fourth bank BANK 4 is continuously refreshed, the JEDEC standard is not entirely matched.

According to an embodiment of the inventive concept, the refresh orders of respective banks may be set with reference to an access prediction result and information about a bank most recently refreshed. For example, as illustrated in FIGS. 18A and 18B, the JEDEC standard is satisfied by refreshing any one from among the first to third banks BANK 1 to BANK 3 predicted to be accessed next and by refreshing the fourth bank BANK 4 that is not predicted to be accessed. Next, the remaining banks BANK 1 and BANK 2 from among the first to third banks BANK 1 to BANK 3 that are predicted to be accessed next may be refreshed.

The above embodiment described a method of arbitrarily selecting any one from among the first to third banks BANK 1 to BANK 3 predicted to be accessed next, but embodiments of the inventive concept are not limited thereto. For example, a bank having a highest prediction probability and a bank having a lowest prediction probability may be differentiated from each other when a bank to be accessed next is predicted, and the bank having the lowest prediction probability may be refreshed prior to the fourth bank BANK 4. Alternatively, in the above embodiments, when any one of the banks is predicted to be accessed next and a refresh order of a bank physically or logically adjacent thereto is changed, any one of the adjacent banks may be refreshed prior to the fourth bank BANK 4.

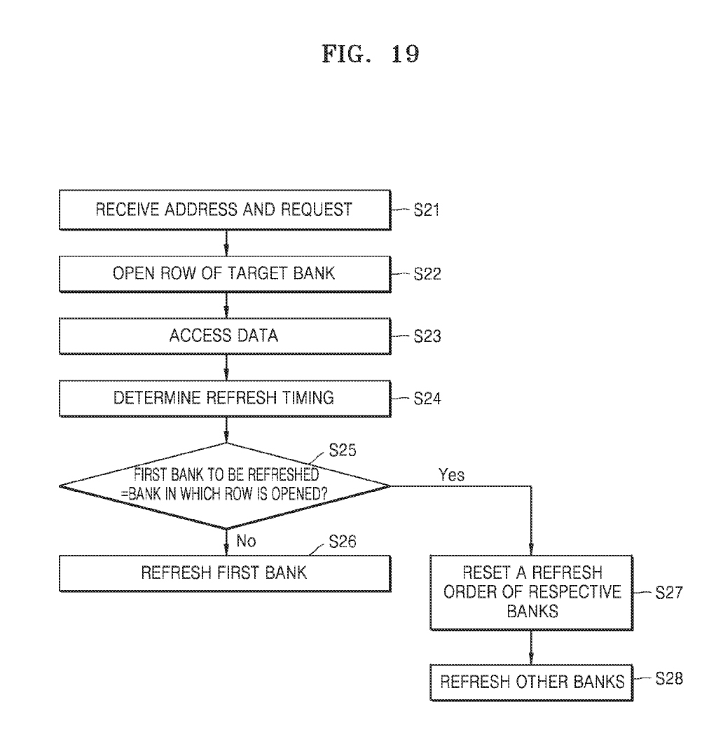

FIG. 19 is a flowchart illustrating an operating method of a memory system, according to another embodiment of the inventive concept.

As illustrated in FIG. 19, the memory system may receive an address representing memory cells requested for access via a request for access corresponding to data from a host (S21). A bank requested for access (for example, a target bank) of the memory device may be determined by analyzing the received address, and a row of the target bank may be opened (S22). After a prescribed time elapses after the row is opened, the data may be accessed as a signal having column information is provided to the memory device (S23).

The memory system may manage refresh operations corresponding to a plurality of banks in order to retain data stably. The memory controller determines refresh timing (S24), designates a bank according to currently set a refresh order of respective banks, and performs the refresh operation.

The memory controller determines whether the bank to be currently refreshed (for example, first bank) is the bank in which a row is opened in order to access data, before generating a bank address to designate a bank to be refreshed (S25). That is, in a state when the row is opened to access data as described above, a refresh operation for a bank in which a row is not opened may be performed regardless of an open/close state of rows of other banks, while a closing operation for the row is required when the bank in which the row is opened is refreshed.

The first bank may be refreshed when at least one row of the first bank to be refreshed according to an order currently set is not opened (S26). However, when at least one row of the first bank to be refreshed is already opened, the refresh orders of respective banks are reset in order to prevent matching the bank in which the row is opened with the bank to be refreshed (S27). The bank to be refreshed currently may be changed by resetting the order, and thus refresh operations for other banks rather than the first bank may be performed (S28).

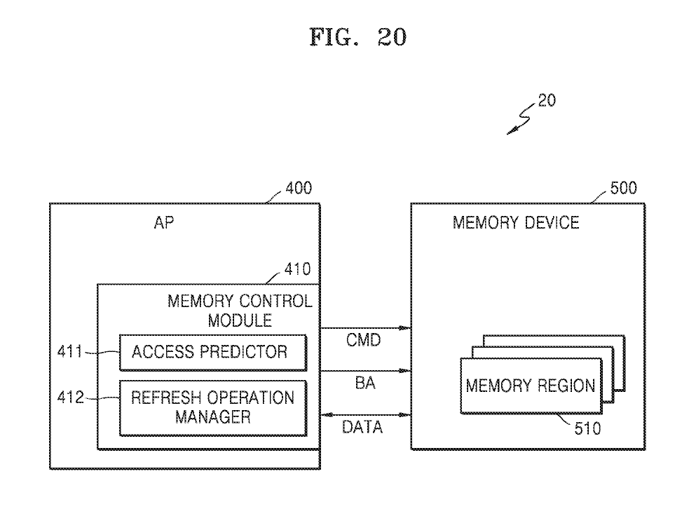

FIG. 20 is a block diagram illustrating a data process system including a memory controller and a memory device, according to an embodiment of the inventive concept.

As illustrated in FIG. 20, a data process system 20 includes an application processor 400 operating as a host and a memory device 500. Various types of memories may be used as the memory device 500. For example, a DRAM according to the above exemplary embodiments or other various memory devices (for example, nonvolatile memory such as a resistive memory) requiring a refresh operation may also be used as the memory device 500. Furthermore, although not shown in FIG. 20, a memory device according to an exemplary embodiment may be realized as an embedded memory in the application processor 400.

The application processor 400 may be realized as a system on chip (SoC). The SoC may include a system bus (not shown) using a protocol based on a predetermined bus standard. Various Intellectual Properties (IPs) may be connected to the system bus. An advanced microcontroller bus architecture (AMBA) protocol of Advanced RISC Machines (ARM) Limited may be applied as a system bus standard. An advanced high-performance bus (AHB), an advanced peripheral bus (APB), an advanced extensible interface (AXI), AXI4, AXI Coherency Extensions (ACE) may be included in a bus type of the AMBA protocol. Besides, other protocol types such as uNetwork of SONICs Inc., CoreConnect of IBM, or an open core protocol of OCP-IP may also be used.

The application processor 400 includes a memory control module 410 in order to control the memory device 500. The memory control module 410 may correspond to the memory controller according to the above exemplary embodiments. Furthermore, the memory device 500 includes a plurality of memory regions 510 respectively including memory cells, and each of the memory regions may correspond to one of the banks described above. Accordingly, the memory control module 410 includes an access predictor 411 and a refresh operation manager 412, and may manage a memory operation of the memory device 500 in a region unit according to the above exemplary embodiments. In the refresh operation, the access predictor 411 may determine a memory region currently requested for access and/or a memory region predicted to be accessed next, and may provide the determination result. The refresh operation manager 412 may set a refresh order of the memory regions 510 based on the determination result.

The memory control module 410 may provide a command CMD and a bank address BA in order to perform the refresh operation corresponding to the memory device 500 according to set refresh orders. Furthermore, data DATA may be transceived between the application processor 400 and the memory device 500 according to the memory operation such as data access.

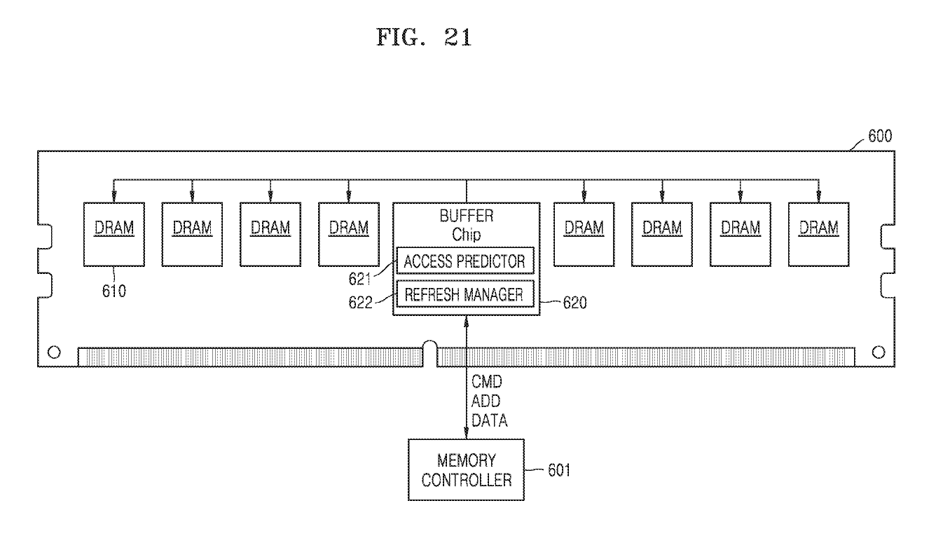

FIG. 21 is a view illustrating a memory module, according to an embodiment of the inventive concept.

Referring to FIG. 21, a memory module 600 includes a plurality of memory chips 610 and a buffer chip 620. The memory module 600 may include various types of memory modules, for example, a load reduced dual in-line memory module (LR-DIMM) or other memory modules. The memory module 600 may receive a command CMD, an address ADD, or data DATA from a memory controller 601 connected thereto via the buffer chip 620.

The buffer chip 620 may control refresh operations of the memory chips 610 according to the command CMD and the address ADD received from the memory controller 601. Furthermore, the buffer chip 620 may manage respective refresh operations for a plurality of banks in each of the memory chips 610 according to the above exemplary embodiments. That is, an access prediction operation and/or a refresh order-setting operation may be performed in the buffer chip 620 in the present described embodiment.

Accordingly, the buffer chip 620 includes an access predictor 621 and a refresh manager 622. The access predictor 621 may determine a memory region currently requested for access and/or a memory region predicted to be accessed next by analyzing the address ADD received from the memory controller 601. The refresh operation manager 622 may set a refresh order of the memory regions 610 based on the determination result.

In the embodiment described the access prediction operation and/or the refresh order-setting operation are performed in the buffer chip 620, but embodiments of the inventive concept are not limited thereto. For example, the access prediction operation may be performed in the memory controller 601, and the memory controller 601 may provide additional information representing the access prediction result to the buffer chip 620. The buffer chip 620 may manage the respective refresh operations for the banks in each of the memory chips 610 with reference to the additional information provided from the memory controller 601.

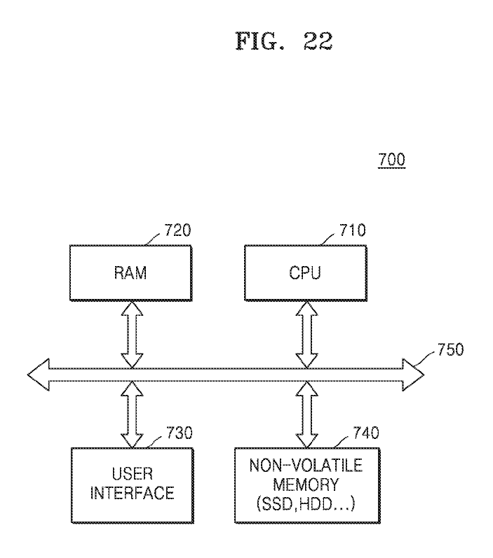

FIG. 22 is a block diagram illustrating a computing system including a memory system, according to an embodiment of the inventive concept. The memory device of the inventive concept may be random access memory (RAM) 720 installed in a computing system 700 such as a mobile device or a desktop computer. Any one of the above embodiments may be used as the memory device installed as the RAM 720. Furthermore, a memory controller of the inventive concept may be formed in the RAM 720 or realized in a central processor 710 as a memory control module.

The computing system 700 according to an embodiment of the inventive concept includes the central processor 710, the RAM 720, a user interface 730, and a nonvolatile memory 740, which are respectively electrically connected to a bus 750. Mass storage devices such as a solid state drive (SSD) or a hard disk drive (HDD) may be used as the nonvolatile memory 740.

As the memory device (or the memory system) according to the present embodiment is used in the computing system 700, the memory controller installed in the RAM 720 and/or the memory control module installed in the central processor 710 may perform the access prediction operation and/or the refresh order-setting operation according to embodiments of the inventive concept. That is, the RAM 720 includes a plurality of memory regions (for example, banks) and a refresh operation corresponding to each of the bank may be managed.

As is traditional in the field of the inventive concepts, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the inventive concepts. Likewise, the blocks of the embodiments may be physically combined into more complex blocks without departing from the scope of the inventive concepts.

While the inventive concept has been particularly shown and described with reference to exemplary embodiments thereof, it will be understood that various changes in form and details may be made therein without departing from the spirit and scope of the following claims.

What is claimed is:

1. An operating method of a memory controller configured to manage an access operation corresponding to a plurality of banks, the operating method comprising:
determining one bank among the plurality of banks that is requested for access, by analyzing an address;
selecting at least one bank among the plurality of banks that is predicted to be accessed based on a result of the determining;
setting a refresh order of the plurality of banks based on a result of the selecting; and
controlling refresh operations for the plurality of banks based on the refresh order.

2. The operating method of claim 1, wherein the selecting the at least one bank is performed based on a probability of the access corresponding to each of the plurality of banks, the probability being determined based on an access history related to a request for access and a bank address corresponding to the request for access.

3. The operating method of claim 1, wherein the selecting the at least one bank includes selecting at least one other bank related to the banks requested for access, based on a state of data information stored in the banks in a unit including a plurality of pieces of data.

4. The operating method of claim 1, wherein the selecting the at least one bank includes selecting at least one of banks that are not refreshed from among the plurality of banks, based on the result of the determining.

5. The operating method of claim 1, wherein the setting the refresh order of the plurality of banks includes setting the refresh order of at least one bank predicted to be accessed next so as to be refreshed later than other banks.

6. The operating method of claim 1, wherein the setting the refresh order of the plurality of banks includes changing a refresh order of the banks that are not refreshed from among the plurality of banks based on the result of the selecting.

7. The operating method of claim 1, wherein the at least one bank includes first to Nth banks, N being an integer that is equal to or greater than two, and
a second bank is controlled to be refreshed later than other banks when the first bank is requested for access and the second bank is predicted to be accessed next.

8. The operating method of claim 1, wherein the at least one bank includes first to Nth banks, N being an integer that is equal to or greater than two, and
the first bank and a second bank are controlled to be refreshed later than other banks when the first bank is requested for access and the second bank is predicted to be accessed next.

9. The operating method of claim 1, wherein each of the plurality of banks includes a plurality of rows,
the refresh operation is performed in a row unit of each of the plurality of banks, and
the setting the refresh order of the plurality of banks includes setting a refresh order of any one of the plurality of rows of each of the plurality of banks.

10. The operating method of claim 1, wherein the controlling the refresh operations includes providing a refresh command and a bank address to a memory device based on the refresh order.

11. The operating method of claim 1, wherein the memory controller is a memory control module included in an application processor.

12. An operating method of a memory controller configured to manage a plurality of memory regions, the operating method comprising:
performing refresh operations corresponding to one or more regions among the plurality of memory regions;
receiving a request for access from an external device and an address corresponding to the request for access;
changing a refresh order of remaining memory regions that are not refreshed based on the address; and
performing the refresh operations corresponding to the remaining memory regions based on the changed refresh order.

13. The operating method of claim 12, wherein the plurality of memory regions are banks.

14. The operating method of claim 12, wherein the changing the refresh order includes changing the refresh order based on a bank currently requested for access and/or a bank predicted to be accessed next.

15. The operating method of claim 12, wherein the changing the refresh order includes changing the refresh order so that a bank having at least one row which is already opened to access data may not be refreshed.

16. An operating method of a memory system comprising a plurality of banks including a first bank and a second bank, the operating method comprising:
selecting the first bank requested for access according to an external address;
referencing information in order to determine the second bank predicted to be accessed;
adjusting a refresh order of the second bank in order not to match a bank to be accessed and a bank to be refreshed;
accessing data to the first bank; and
refreshing the second bank after finishing a data access operation to the second bank and a row of the second bank is closed.

17. The operating method of claim 16, wherein an access command for data accessing and a refresh command for a refresh operation are stored in a command queue, and
the adjusting the refresh order includes changing positions of the commands stored in the command queue based on a result of the determining the second bank predicted to be accessed.

18. The operating method of claim 17, wherein the memory system comprises a memory controller and a memory device, and
the refresh operation is performed by a bank address provided from the memory controller based on the result of the determining the second bank predicted to be accessed and by a refresh address.

19. The operating method of claim 16, wherein each of the plurality of banks comprises a plurality of rows, and
the refresh order for first rows of the plurality of banks and the refresh order of second rows of the plurality of banks are different from each other.

20. The operating method of claim 16, wherein the memory system includes a table storing the information comprising an access history, and
the information references the table.
